(19) United States
(12) Patent Application Publication
(10) Pub. No.: US 2017/0169439 A1
(43) Pub. Date: Jun. 15, 2017

(54) SYSTEM AND METHOD FOR APPLICATION MANAGEMENT

(71) Applicant: OPTiM Corporation, Saga (JP)

(72) Inventor: Shunji SUGAYA, Tokyo (JP)

(21) Appl. No.: 15/066,012

(22) Filed: Mar. 10, 2016

(30) Foreign Application Priority Data
Dec. 15, 2015 (JP) 2015-244561

(51) Int. Cl. G06Q 30/00; G06F 3/0484; G06Q 30/06

(52) U.S. Cl. CPC G06Q 30/018; G06Q 30/0609; G06F 3/04842

(57) ABSTRACT

The present invention is to provide a system and a method for application management to effectively manage an application used in a plurality of terminals with different operating systems even if the purchaser is different from the user. The system for application management 1 that manages an application when the purchaser of the application is different from the user, stores management information associating attribute information on the user with information on a communication terminal that the user uses; collectively displays an application supporting a different operating system on the management terminal 150; allows the purchaser to select an application that the purchaser wishes to have the user to use from the collectively displayed application supporting a different operating system and then allows the purchaser to purchase a license of the application; and distributes the application under the purchased license according to the operating system of the communication terminal.

### CROSS REFERENCE TO RELATED APPLICATIONS

This application claims priority to Japanese Patent Application No. 2015-244561 filed on Dec. 15, 2015, the entire contents of which are incorporated by reference herein.

### TECHNICAL FIELD

The present invention relates to a system and a method for application management to manage an application used in a computer terminal, a computer device, and a portable terminal.

### BACKGROUND ART

Recently, applications to be used in computer terminals have been downloaded from WEB pages called application store sites through a public line network such as the Internet.

For example, the application store site of Non-Patent Document 1 discloses a WEB page to allow a user to download an application to be used in a smart phone, a tablet terminal, a notebook computer, etc. Thus, the user accesses, downloads, and installs an application that the user is to use through a user's computer.

Moreover, a technology to coordinate the user and the purchaser if the user of an application is different from the user who purchases the application is disclosed (for example, Patent Document 1). This allows the user to obtain applications without paying for the purchaser.

### CITATION LIST

### Patent Literature

Patent Document 1: JP 2014-153836A

### Non-Patent Literature

Non-Patent Document 1: Apple Japan, “ITunes”, online, Apple Japan, and retrieved on Dec. 12, 2015, Internet, http://www.apple.com/jp/itunes/download

### SUMMARY OF INVENTION

However, it takes time and trouble to install, for example, a plurality of common applications from only these application store sites to computer terminals such as a large number of smart phones and tablet terminals even if the above-mentioned conventional technologies are used. Specifically, computer terminals in which applications are to be installed have to be started up one by one to access application store sites and to purchase, download, and install suitable applications. This requires an amount of time and trouble in proportion to the number of terminals in which applications are to be installed.

In addition, existing application store sites provide only applications supporting the operating system that they offer. For example, the sales site shown in Non-Patent Document 1 provides only applications supporting the operating system available from Apple Computer Inc., but not from Google Inc. Therefore, terminals with different operating systems have to access different application store sites in each operating system according to install applications even if the application is the same.

An objective of the present invention is to provide a system and a method for application management to effectively manage an application used in a plurality of terminals with different operating systems even if the purchaser is different from the user.

The first aspect of the present invention provides a system for application management, the system that manages an application when the purchaser of the application is different from the user, including:

a management information storing unit (e.g., memory unit 40) that stores management information associating attribute information on the user with information on a communication terminal that the user uses;

a display unit (e.g., input display unit 140) that collectively displays an application supporting a different operating system;

a license purchase unit (e.g., purchase-receiving display module 137) that allows the purchaser to select an application that the purchaser wishes to have the user to use from the collectively displayed application supporting a different operating system and then allows the purchaser to purchase a license of the application; and

an application distribution unit (e.g., application distribution module 34) that distributes the application under the purchased license according to the operating system of the communication terminal.

According to the first aspect of the present invention, a system for application management, the system that manages an application when the purchaser of the application is different from the user,

stores management information associating attribute information on the user with information on a communication terminal that the user uses;

collectively displays an application supporting a different operating system;

allows the purchaser to select an application that the purchaser wishes to have the user to use from the collectively displayed application supporting a different operating system and then allows the purchaser to purchase a license of the application; and

distributes the application under the purchased license according to the operating system of the communication terminal.

The second aspect of the present invention provides the system according to the first aspect of the present invention, in which the display unit and the purchase unit perform through a Web page for the purchaser.

The third aspect of the present invention provides the system according to the first aspect of the present invention, in which the display unit and the purchase unit perform through an application for the purchaser.

The fourth aspect of the present invention provides the system according to the first aspect of the present invention further includes a deletion unit (e.g., application change module 35) that deletes an application distributed from the application distribution unit from the communication terminal if the attribute information is changed.

The fifth aspect of the present invention provides the system according to the first aspect of the present invention further includes an application change unit (e.g., application change module 35) that changes an application to be distributed from the application distribution unit if the attribute information is changed.

The sixth aspect of the present invention provides the system according to the first aspect of the present invention, in which the display unit arranges and displays an application supporting a different operating system according to each operating system.

The seventh aspect of the present invention provides the system according to the first aspect of the present invention, in which the display unit displays the number of license for application purchased in the past.

The eighth aspect of the present invention provides a method for application management, the method executed by a system for application management when the purchaser of the application is different from the user, including the steps of:

storing management information associating attribute information on the user with information on a communication terminal that the user uses;

collectively displaying an application supporting a different operating system;

allowing the purchaser to select an application that the purchaser wishes to have the user to use from the collectively displayed application supporting a different operating system and then allowing the purchaser to purchase a license of the application; and

distributing the application under the purchased license according to the operating system of the communication terminal.

The present invention can provide a system and a method for application management to effectively manage an application used in a plurality of terminals with different operating systems even if the purchaser is different from the user.

### BRIEF DESCRIPTION OF DRAWINGS

FIG. 1 shows a system configuration diagram of the system for application management as a preferable embodiment of the present invention.

FIG. 2 shows a functional block diagram illustrating the hardware and the software configurations of the application management server 100 and the management terminal 150.

FIG. 3 shows a flow chart of the application distribution process performed by the application management server 100 and the management terminal 150.

FIG. 4 shows a flow chart of the attribute information change process performed by the application management server 100 and the management terminal 150.

FIG. 5 shows the attribute information data table that the application management server 100 stores.

FIG. 6 shows the terminal information data table that the application management server 100 stores.

FIG. 7 shows a screen image (home screen) of the application store site displayed on the management terminal 150.

FIG. 8 shows a screen image (purchase page) of the application store site displayed on the management terminal 150.

FIG. 9 shows a screen image of the license number notification displayed on the terminal 50, 60 of the user.

FIG. 10 shows a screen image of the application store site (home screen showing applications according to each OS) displayed on the management terminal 150.

### DESCRIPTION OF EMBODIMENTS

Embodiments of the present invention will be described below with reference to the attached drawings. However, this is illustrative only, and the technological scope of the present invention is not limited thereto.

### System Configuration

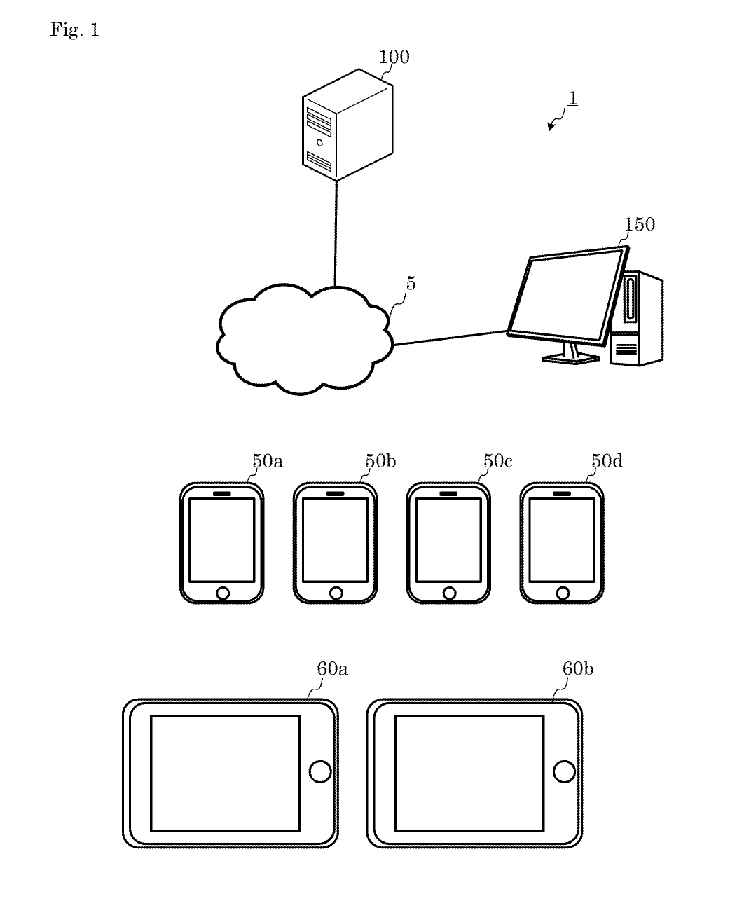

FIG. 1 shows a system configuration diagram of the system for application management as a preferable embodiment of the present invention. The application management system 1 includes an application management server 100, a management terminal 150 that a purchaser uses, a communication terminal 50a to 50d, 60a, 60b that a user uses, a communication line network 5 which may be, for example, a public line network such as the Internet network, a fourth generation communication network (the communication generation is one example), or LTE, a private line network, a local area network (hereinafter referred to as “LAN”), or the combination of these. The application management server 100, the management terminal 150 that the purchaser uses, and the communication terminal 50a to 50d, 60a, 60b that the user uses are communicatively connected through the communication line network 5. These devices may be communicated through a wireless or wired network as shown in FIG. 1.

The application management server 100 may be a computer server with a typical database, which may include one server or two or more servers. The application management server 100 may also have a WEB server function.

The management terminal 150 and the communication terminal 50a to 50d, 60a, 60b are an information-communication terminal capable of executing applications called programs. As hardware, examples of these terminals may include information electrical appliances such as a computer terminal, a personal computer, a notebook computer, a smart phone, a tablet terminal, a television, a mobile phone, a portable information terminal, an electronic book terminal, a portable music player, an audio component, a content player and recorder, a printer, a multi-purpose peripheral, an uninhabited airborne vehicle, a robot, a wearable terminal, a watch, and a cameras that have a capability of connecting to a network. The communication terminal 50a to 50d, 60a, 60b will be described below as the communication terminal 50 when the type of the terminal is not distinguished.

The management terminal 150 is a terminal used by the purchaser (administrator) who purchases an application to be used in the communication terminal 50. For example, the management terminal 150 is a terminal used by a person in charge of the information and research department of a company, etc. On the other hand, the communication terminal 50 is a terminal in which the management terminal 150 installs an application.

The application in this embodiment may be an application program executed by only the communication terminal 50 or by a server in cooperation with the communication terminal 50. The communication terminal 50 may have only a browser to input and output the result of an application executed by the server.

### Configuration of Application Management Server 100 and Management Terminal 150

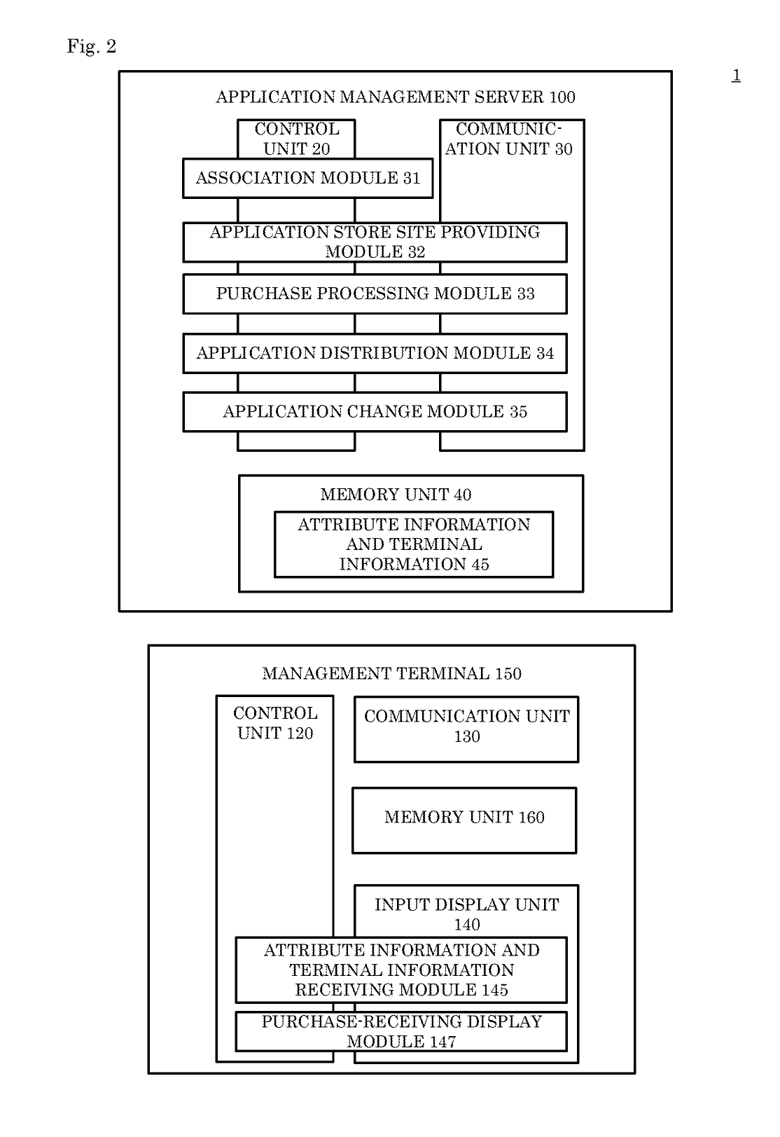

FIG. 2 shows a functional block diagram illustrating the hardware and the software configurations of the application management server 100 and the management terminal 150.

The application management server 100 has a capability of selling and distributing an application. Specifically, the application management server 100 provides an application store site. The application management server 100 at least includes a control unit 20 that controls image data and information, a communication unit 30 that communicates with other computers, and a memory unit 40 that stores data.

The control unit 20 includes a central processing unit (hereinafter referred to as “CPU”), a random access memory (hereinafter referred to as “RAM”), and a read only memory (hereinafter referred to as “ROM”). The communication unit 30 includes a device communicative with other devices, for example, a module that connects with a communication line network such as LAN to achieve communication. The memory unit 40 includes a data storage unit such as a hard disk, a semiconductor memory, a recording medium, or a memory card for storing data to store the attribute information and the terminal information data tables 45, etc., used in the application management server 100.

In the application management server 100, the control unit 20 reads a predetermined program to achieve an association module 31 that associates attribute information with terminal information. In addition, the control unit 20 reads a predetermined program to achieve an application store site providing module 32 that transmits an application store site to the communication terminal 50, a purchase processing module 33 that performs the purchase process, an application distribution module 34 that distributes an application to the communication terminal 50, and an application change module 35 that changes an installed application in cooperation with the communication unit 30.

The management terminal 150 at least includes a control unit 120 that controls image data and information, a communication unit 130 that communicates with other devices and terminals, a memory unit 160 that stores data, etc., and an input display unit 140 that inputs and displays data.

In the management terminal 150, the control unit 120 reads a predetermined program to achieve an attribute information and terminal information receiving module 145 that receives an input and a change of attribute information and terminal information and a purchase-receiving display module 147 that receives a purchase of an application from a purchaser in cooperation with the input display unit 140.

### Application Distribution Process

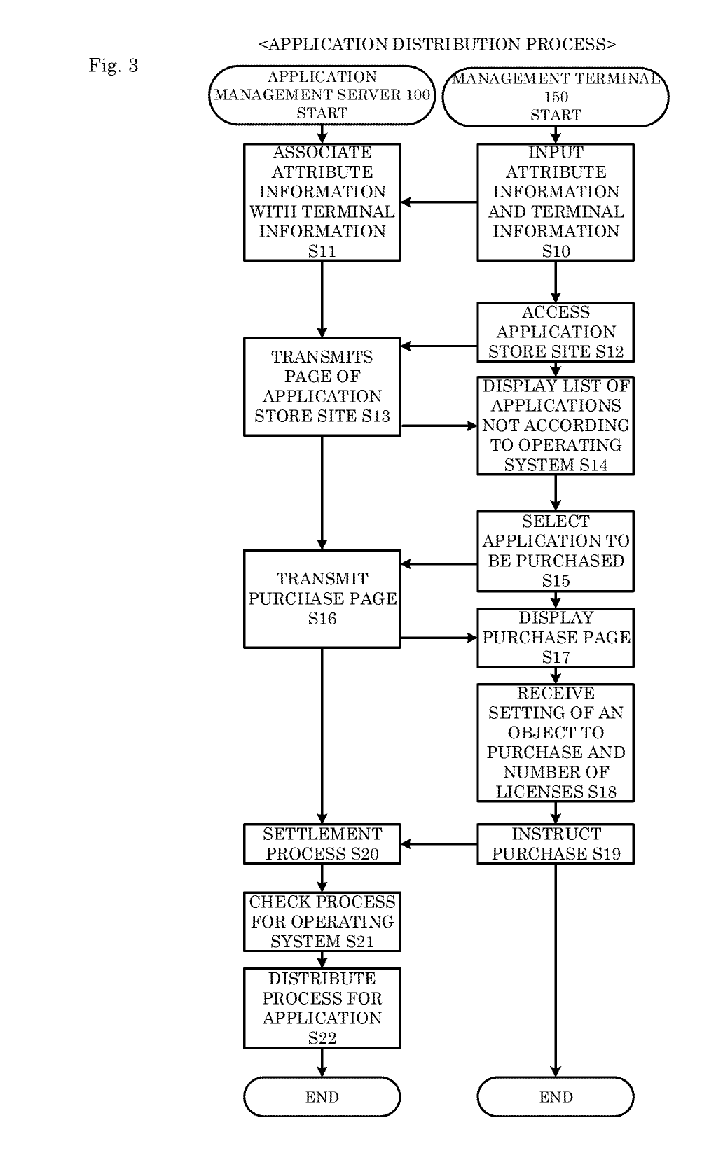

FIG. 3 shows a flow chart of the application distribution process performed by the application management server 100 and the management terminal 150. The tasks executed by the modules of the above-mentioned hardware and software will be explained below together with this process.

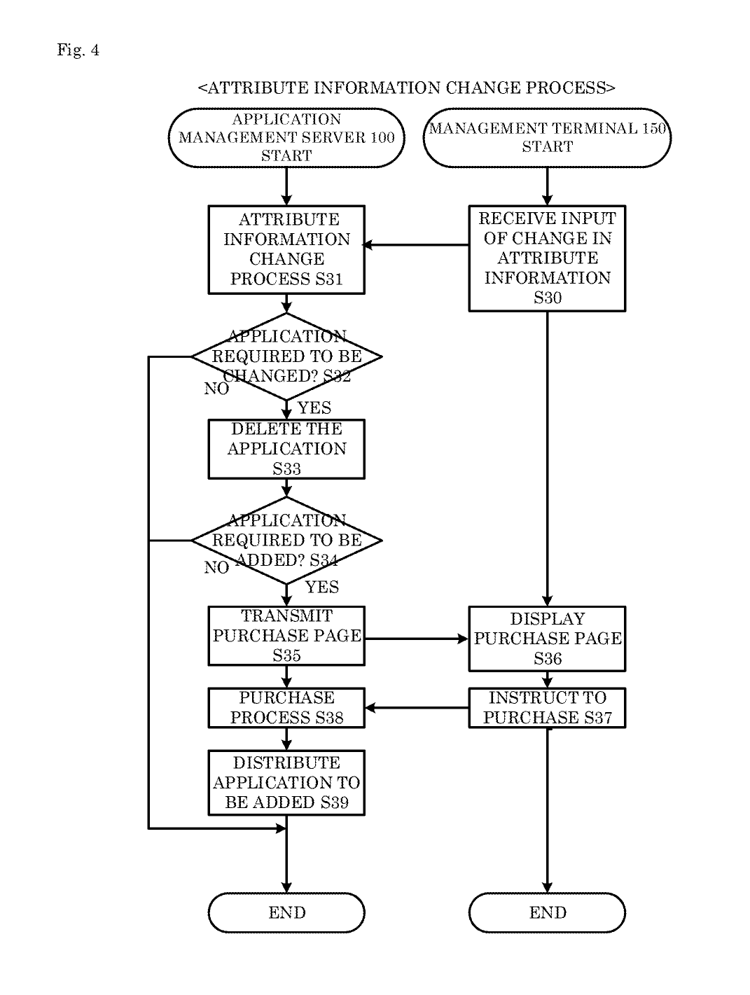

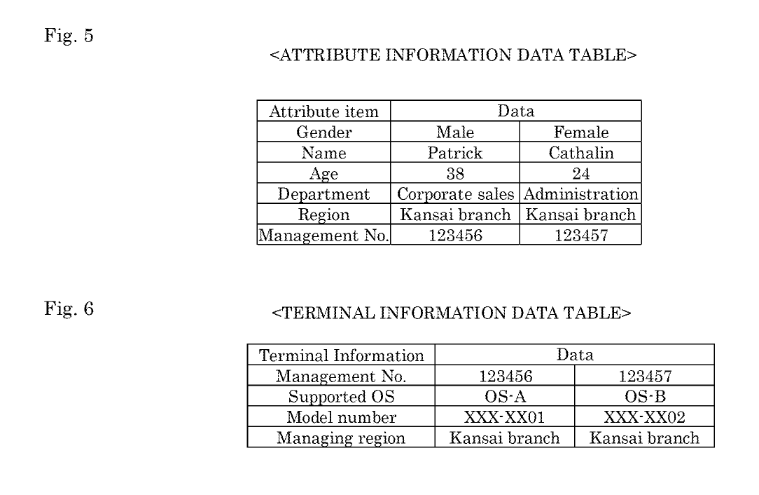

First, the attribute information and terminal information receiving module 145 of the management terminal 150 receives an input of attribute information and terminal information from a purchaser (step S10). The attribute information is on the user who uses the communication terminal 50, which may be data including a gender, a name, an age, a department, and a region as attribute items as shown in FIG. 5. On the other hand, the terminal information is on the communication terminal 50, which may be data including a terminal management number, the name of the operating system supported by a terminal, a terminal model number, and the region managing a terminal as shown in FIG. 6. Input information is stored in an attribute information data table and a terminal information data table in the application management server 100.

Then, the management terminal 150 receives an input of a management number from the purchaser and transmits the management number to the application management server 100. The application management server 100 associates and stores attribute information with the terminal information (step S11). Specifically, since the attribute name “Patrick” owns the terminal management number “123456” as shown in FIG. 5 after the management number input from the management terminal 150 is received, the attribute name is associated with the management number “123456” of the terminal information data table. This shows that the name “Patrick” owns the communication terminal 50 with the management number “123456,” and the terminal has the operating system “OS-A.”

Then, the management terminal 150 accesses the application store site in response to instruction from the purchaser at the timing when the purchaser needs to purchase an application that the user is to use (step S12). The site may be accessed from an application of the management terminal 150. The purchase process to be described later may perform through this application. In response to the access, the application store site providing module 32 of the application management server 100 transmits a WEB page of the application store site to the management terminal 150 (step S13). Then, the purchase-receiving display module 147 of the management terminal 150 receives the transmitted page and displays a list of applications not according to each operating system on the home screen (step S14).

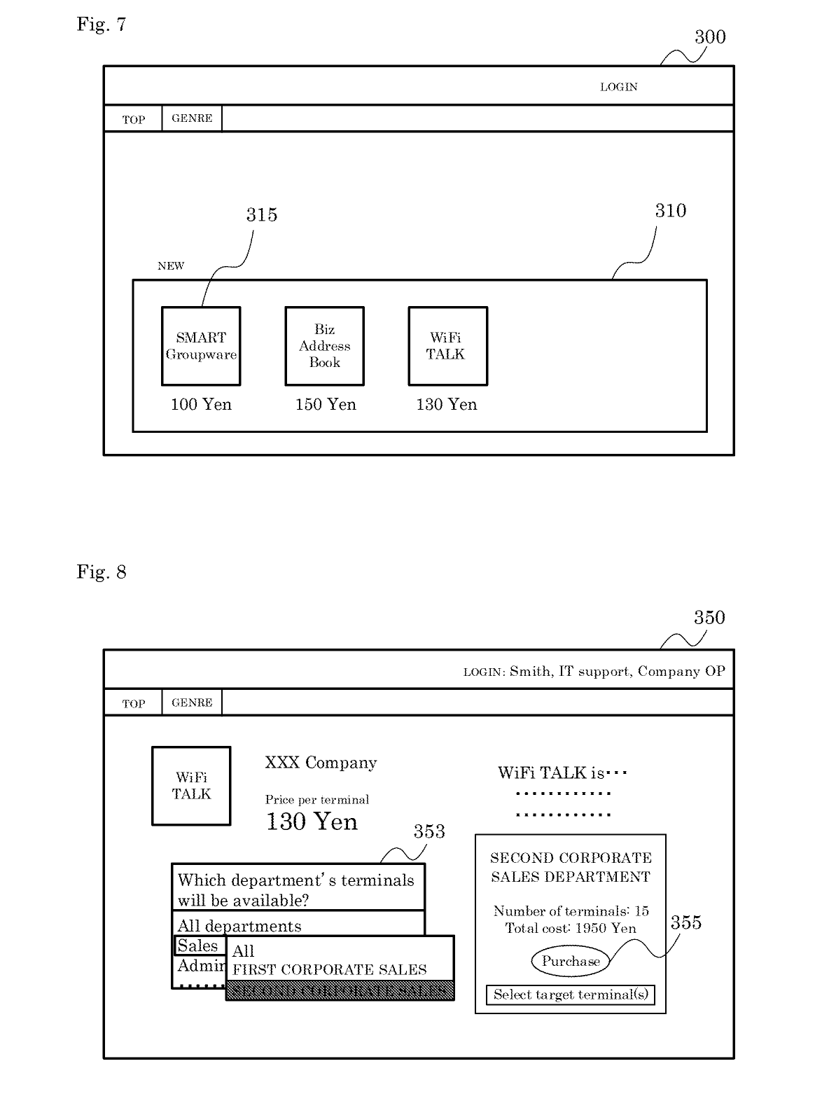

The screen image 300 of FIG. 7 shows a list of applications not according to each operating system displayed on the management terminal 150. Existing application store sites provide only applications to support the operating system that they offer. However, such a display can greatly improve the convenience for a purchaser and a person who installs applications. The list of applications may be arranged and displayed according to each operating system (e.g., OS-A, OS-B) as shown in FIG. 10.

Then, the purchase-receiving display module 147 of the management terminal 150 receives a selection of an application to be purchased in response to input from the purchaser (step S15) and transmits information on the selected application to the application management server 100. Then, the purchase process module 33 of the application management server 100 transmits the purchase page to the management terminal 150 (step S16). The purchase-receiving display module 147 of the management terminal 150 displays the received purchase page (step S17). Then, the purchase-receiving display module 147 receives a setting of a group t to use the application (user's group, e.g., department) and the number of licenses (step S18). The group to use the application may be set from another screen.

FIG. 8 shows one example of the purchase page 350 displayed on the management terminal 150 if the purchaser selects “WiFi TALK” as one of the applications. As shown in this figure, the purchase page 350 at least displays the name, the distributor, the specification, and the price per communication terminal of the application. In this example, the purchaser “Smith, IT support, Company OP” are logging in the system, and the purchase page 350 displays data such as the department of the company OP and receives an input from this purchaser. Briefly, the attribute information on the communication terminal 50 in which the application “WiFi TALK” is to be installed can be selectively input from the management terminal 150. In this figure, “Second corporate sales department” is selected from the selection box 353, and the number of the terminals used in the group, i.e., the second corporate sales department and the total cost are output and displayed as 15 and 1950 yen, respectively.

Then, the purchase-receiving display module 147 of the management terminal 150 instructs the purchase in response to operation of the purchase icon 355 from the purchaser (step S19). The purchase process module 33 of the application management server 100 performs the settlement process for the selected application (step S20).

Then, the application distribution module 34 of the application management server 100 performs the check process for the operating system before the selected application is distributed to each terminal (step S21). Specifically, the application distribution module 34 checks the type of the operating system in the group of communication terminals 50 to which the application is distributed (the second corporate sales department in the example) by looking up the terminal information data table before the selected application is distributed to each terminal.

Then, the application distribution module 34 distributes the application supporting the checked operating system to each communication terminal 50 (step S22). The application may be distributed to each communication terminal from the server of the maker who sells the application that is different from the application management server 100 by instruction from the application distribution module 34. At this time, this application is enabled only after license information on the application is set from the server of the maker who sells the application.

As another embodiment, the application may be enabled only by setting of the license issued from the server of the maker who sells the application without distributing the application. In this case, for example, the application is enabled only by accessing the WEB page of the server and inputting license information through a browser that can be used in the communication terminal 50. At this time, the maker's server distributes the application and issues the license number to the communication terminals 50 according to each operating system based on the check result of the operating system that has been notified from the application management server 100 in response to instruction from the application management server 100.

As another embodiment, the application management server 100 may receive the application and the license number from the maker's server and then distribute the received application and the license number to each communication terminal 50. Alternatively, after the purchaser purchases the license number of the application, the application may be distributed to each communication terminal 50 of the user and enabled only by inputting the license number from the user.

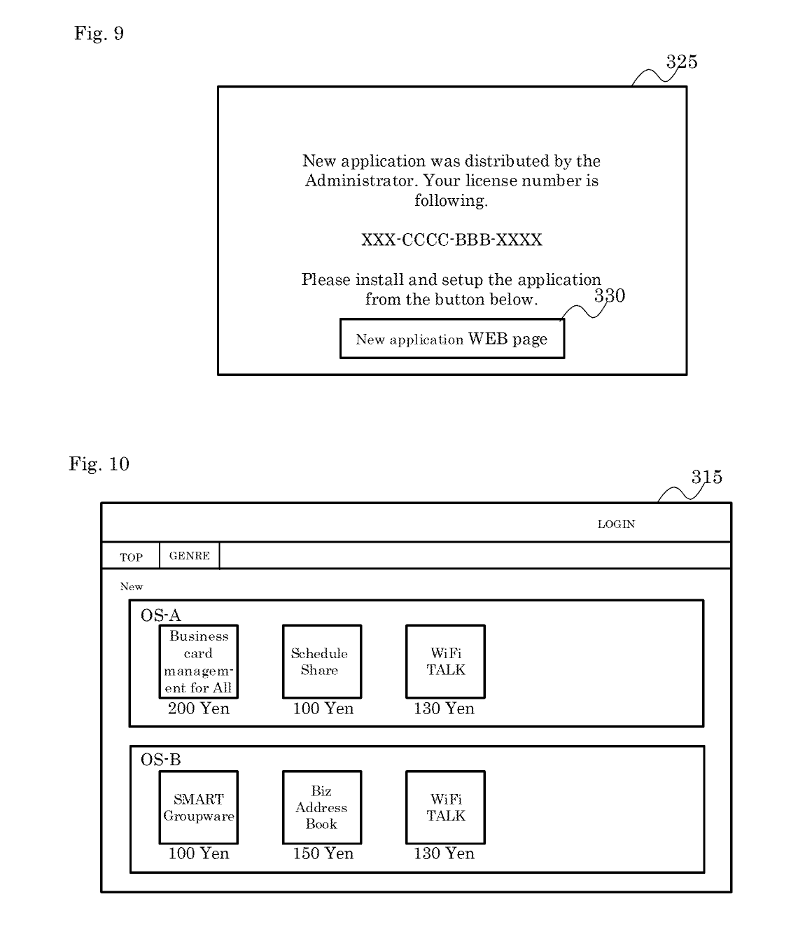

For example, as shown in FIG. 9, the message notifying the license number of a new application is transmitted from the management terminal 150 or the application management server 100 to the communication terminal 50. Then, the user operates the new application WEB page icon 330 to accesses the WEB page and to install and set the new application. This enables the new application to be used.

FIG. 4 shows a flow chart of the attribute information change process performed by the application management server 100 and the management terminal 150. First, the attribute information and terminal information receiving module 145 of the management terminal 150 receives an input of a change in the attribute information (step S30). In the case of a change in the attribute information, the communication terminal 50 or the department of the user is changed. The attribute information and terminal information receiving module 145 transmits the changed attribute information to the application management server 100.

The association module 31 of the application management server 100 receives the changed attribute information and performs the attribute information change process to rewrite the attribute information data table (step S31). Then, the application change module 35 judges whether or not the application installed in the communication terminal 50 is required to be changed based on this changed attribute information (step S32). If judging that the application is required to be changed (“YES” in the step S32), the application change module 35 proceeds to the step S33. On the other hand, if judging that the application change is not required to be changed (“NO” in the step S32), the application change module 35 ends the process.

Then, if the application is required to be changed, the application change module 35 deletes the application (step S33). The deletion of the application means that the communication terminal 50 uninstalls the intended application in response to the delete instruction. As another embodiment, the deletion of the application may means that the application is disabled by invalidating the set license information. For example, when the attribute information of a certain user is changed from “First corporate sales department” to “Administration Department,” the deletion process is performed to delete a predetermined application (e.g., application managing business cards of customers).

Then, the application change module 35 judges whether or not an application is required to be added in the communication terminal 50 based on this changed attribute information (step S34). If judging that an application is required to be added (“YES” in the step S34), the application change module 35 proceeds to the step S35. If judging that an application is not required to be added (“NO” in the step S34), the application change module 35 ends the process.

If an application is required to be added, the application change module 35 transmits the purchase page to the management terminal 150 for the purchase and payment (step S35). Then, the purchase-receiving display module 147 of the management terminal 150 displays the purchase page (step S36) and instructs to purchase the application to the application management server 100 (step S37). Subsequently, the purchase process module 33 performs the settlement process as described above (step S38). After the settlement process, the application distribution module 34 of the application management server 100 distributes the application to the communication terminal 50 with the attribute information changed (step S39).

For example, the process enables the application that can be used in the communication terminal 50 to be easily changed even if the attribute information of the user is changed but the users continues to use the same communication terminal 50. Moreover, the number of licenses of applications purchased in the past may be displayed on the screen of the management terminal 150. In this case, unexpired licenses may be counted and displayed as the number of licenses. Furthermore, if an application is not to be used because the attribute information of the user is changed, the number of the licenses of the remaining distributable applications may be displayed on the screen of the management terminal 150.

To achieve the means and the functions that are described above, a computer (including a CPU, an information processor, and various terminals) reads and executes a predetermined program. For example, a program is provided in a form recorded in a computer-readable recording medium such as a flexible disk, a CD (e.g., CD-ROM), a DVD (e.g., DVD-ROM and DVD-RAM), or a Blu-ray. In this case, a computer reads a program from the record medium, forwards and stores the program to and in an internal or an external storage, and executes it. For example, the program may be previously recorded in a memory (a record medium) such as a magnetic disk, an optical disk, a magnetic optical disk, or a hard disk, and then provided from the memory to the computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to that described in the embodiments of the present invention.

### REFERENCE SIGNS LIST

1 Application management system
100 Application management server
50 Communication terminal
150 Management terminal

What is claimed is:

1. A system for application management, the system that manages an application when the purchaser of the application is different from the user, comprising:
a management information storing unit that stores management information associating attribute information on the user with information on a communication terminal that the user uses;
a display unit that collectively displays an application supporting a different operating system;
a license purchase unit that allows the purchaser to select an application that the purchaser wishes to have the user to use from the collectively displayed application supporting a different operating system and then allows the purchaser to purchase a license of the application; and
an application distribution unit that distributes the application under the purchased license according to the operating system of the communication terminal.

2. The system according to claim 1, wherein the display unit and the purchase unit perform through a Web page for the purchaser.

3. The system according to claim 1, wherein the display unit and the purchase unit perform through an application for the purchaser.

4. The system according to claim 1, further comprising a deletion unit that deletes an application distributed from the application distribution unit from the communication terminal if the attribute information is changed.

5. The system according to claim 1, further comprising an application change unit that changes an application to be distributed from the application distribution unit if the attribute information is changed.

6. The system according to claim 1, wherein the display unit arranges and displays an application supporting a different operating system according to each operating system.

7. The system according to claim 1, wherein the display unit displays the number of license for application purchased in the past.

8. A method for application management, the method executed by a system for application management when the purchaser of the application is different from the user, comprising the steps of:
storing management information associating attribute information on the user with information on a communication terminal that the user uses;
collectively displaying an application supporting a different operating system;
allowing the purchaser to select an application that the purchaser wishes to have the user to use from the collectively displayed application supporting a different operating system and then allowing the purchaser to purchase a license of the application; and
distributing the application under the purchased license according to the operating system of the communication terminal.
